(19) United States
(12) Patent Application Publication
(10) Pub. No.: US 2002/0087472 A1
(43) Pub. Date: Jul. 4, 2002

(54) Data privacy encoding for consumer input media

(76) Inventor: Joanne S. Walter, Alpharetta, GA (US)

Correspondence Address: Paul W. Martin, NCR Corporation, Law Department, ECD-2, 101 W. Schantz Avenue, Dayton, OH, 45479-0001, US

(21) Appl. No.: 09/751,630

(22) Filed: Dec. 29, 2000

(51) Int. Cl. G06F 17/60

(52) U.S. Cl. 705/41

(57) ABSTRACT

A system, method and apparatus for allowing a consumer to configure their own personal privacy preferences or privacy data model to prescribe the type of personal data that can be obtained from the consumer. The consumer's privacy data model is encoded into a barcode or other machine readable marking(s), or onto a key flock or card via a personal computer (PC), personal digital assistant (PDA), cell phone, or the like. The encoded privacy data model provides an access to the consumer's privacy preferences at the point of sale or the point of service for a business. This allows the consumer to opt in or out of various aspects of personal data collection and/or use as well as the collection of any data. The code can be accessed through a consumer's personal web page or a store's database.

### FIELD OF THE INVENTION

The present invention relates generally to the gathering of personal privacy data during purchase transactions and, more particularly, to a system, method and/or apparatus for permitting a consumer to prescribe personal privacy data preferences obtainable during transactions.

### DESCRIPTION OF THE PRIOR ART

Personal data is collected or attempted to be collected by almost every business at almost every opportunity. In addition to an entire range of demographic data, collectible personal data includes product and service purchase data encompassing type and amount of products and/or services purchased, frequency of purchase, time of purchase, whether coupons were used, and the like, as well as mode of payment data, place or manner of purchase (e.g. on-line, catalog, television), and any other information. This may be accomplished through the use of paper such as by warranty cards. Typically, however, this information is obtained by electronic means.

The collection of personal data from a consumer is relatively easy given today's electronic environment. Personal data from electronic purchase transactions is readily collected, stored, and analyzed, sometimes without the knowledge of the consumer. The collected personal data is typically used by companies for marketing and other purposes. Some or all of the collected personal data may also be sold for various purposes again, without the knowledge of the consumer.

Because of a potential for abuse and/or privacy concerns with regard to the collected personal data, it has been recognized that there needs to be rules and/or limits on the collection and/or use of personal data. Customers may not want to give certain information to a company for a variety of reasons. In some instances, companies may not have a right to collect and/or freely use some types of personal data. However, since personal data is useful to the company, the company wants to obtain such personal data.

In consideration of the above, companies have developed rules regarding the collection and/or use of personal data. The rules typically include how the data is used, whether the data will be sold to third parties or disseminated in general, and others. Additionally, these rules should involve seeking permission from the consumer for the company to obtain various types of personal data. However, implementation of personal privacy rules have heretofore been clumsy, impractical, been accomplished only via paper, or suffered from other defects.

Thus, it would be desirable to have a system, method and/or apparatus for allowing a consumer to control the type of personal data that may be collectible during a transaction.

It would also be desirable to have a system, method and/or apparatus for allowing a consumer to modify and/or set up a privacy profile or prescribe personal privacy preferences.

It would also be desirable to have a system, method and/or apparatus for allowing a consumer to opt in or out of a particular privacy data model.

### SUMMARY OF THE INVENTION

The present invention provides a system, method and apparatus for allowing a consumer to prescribe their own personal data preferences. This is preferably accomplished via a consumer device over a network. The prescribed personal data preferences are then coded and downloaded to a code storage media via the consumer device.

In one form, the present invention is a method for consumer prescribing of personal data preferences. The method includes the steps of: (a) allowing access to a personal data preferences program via a consumer device; (b) allowing a consumer to select personal data privacy preferences via the consumer device; (c) coding the selected personal data preferences; (d) downloading the coded personal data preferences to the consumer device; and (e) allowing the consumer device to transfer the coded personal data preferences to a storage media.

In another form, the present invention is a method of encoding personal data preferences of a consumer for use during a purchase transaction. The method includes the steps of: (a) accessing a personal data preferences program via a consumer device; (b) permitting selection of personal data preferences via the consumer device; (c) encoding the selected personal data preferences; and (d) downloading the encoded selected personal data preferences to the consumer device.

In still another form, the present invention is a system that is operable to allow a consumer to prescribe personal data preferences and download the preferences to a storage medium that is operable to be read during a purchase transaction.

The present invention provides a consumer the ability to download and maintain personal privacy preferences that are accessed during a transaction. The personal privacy preferences indicate what type of personal data may be collected and how that data may be used.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram of a system operable to implement the principles of the present invention;

FIG. 2 is a block diagram of the P.O.S. terminal of FIG. 1;

FIG. 3 is a representation of a consumer/business transaction utilizing a loyalty card in accordance with the principles of the present invention; and

FIG. 4 is a flowchart of a method in accordance with the principles of the present invention.

Corresponding reference characters indicate corresponding parts throughout the several views.

### DETAILED DESCRIPTION

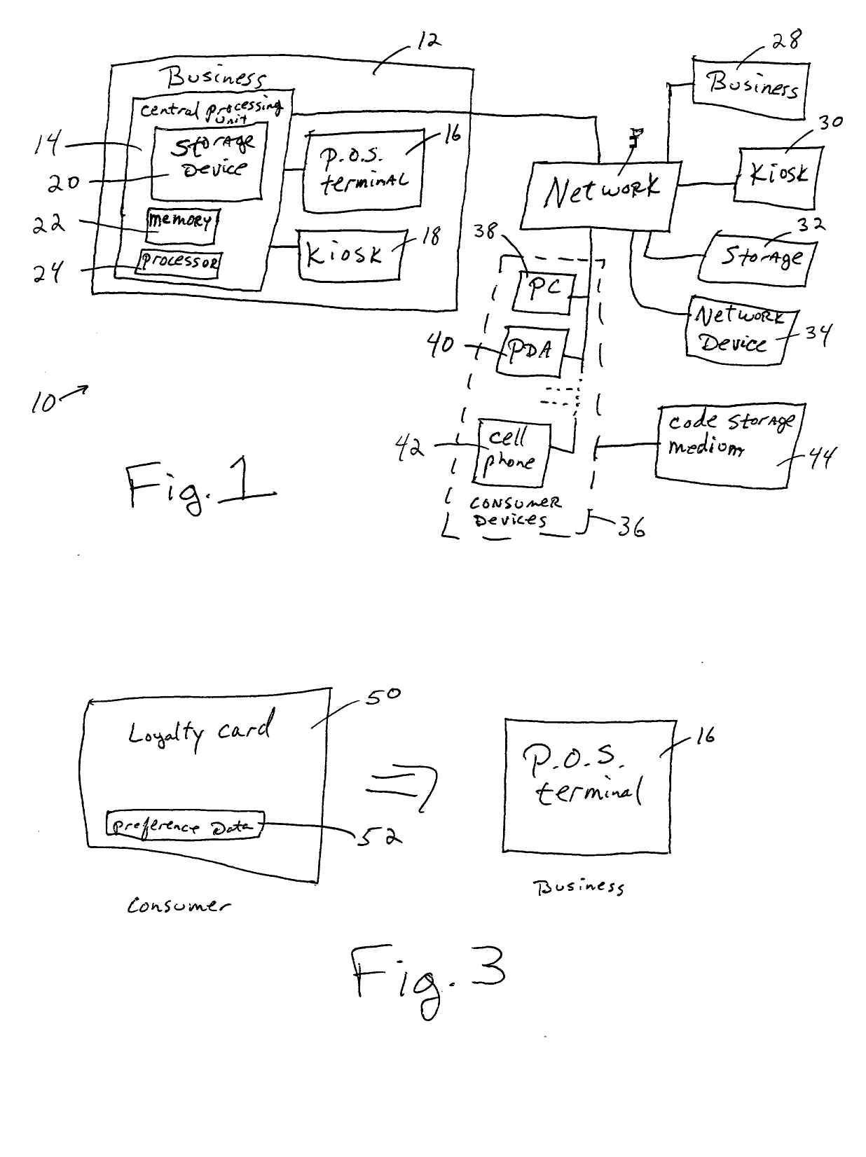

Referring now to FIG. 1, there is depicted a diagram of an overall system, collectively generally designated 10, that is able implement the various aspects and/or principles of the present invention. It should initially be understood that the system 10 as depicted in FIG. 1 is representative or exemplary of a system whose components, either individually, in parts, or in whole, as the case may be, are operable in the manner set forth herein. The system 10 is not intended to be an exact representation of any particular system nor is it intended to imply that only this type of system may implement the various aspects and/or principles of the present invention. The system 10 as shown in FIG. 1 provides a basic model for understanding the various aspects and/or principles of the present invention, the various forms through which the various aspects and/or principles of the present invention may be manifested, and the many ways in which the various aspects and/or principles of the present invention may be carried out.

A business 12 is shown having a central processing unit or device 14, a point of service (P.O.S.) terminal 16, and a kiosk 18. The central processing unit 14 represents a central computer or computing device for the business. The P.O.S. terminal 16 may be any type thereof such as those manufactured by NCR Corporation of Dayton, Ohio, that are used to consummate a purchase or business transaction. The P.O.S. terminal 16 may be a self-service check-out type terminal, a clerk assisted type terminal, combination thereof, or any other type of device capable of functioning in the manner set forth herein. It should be appreciated that the business 12 may have more than one P.O.S. terminal, and typically has several P.O.S. terminals. The description and/or function(s) of the P.O.S. terminal 16 thus applies to all such P.O.S. terminals. As well, the business 12 may or may not have a kiosk 18 or similar/equivalent device, or several kiosks located throughout the store. The description and/or function(s) of the kiosk 18 thus applies to all such kiosks.

The P.O.S. terminal 16 is in communication with the central processing unit 14 either via a direct connection or network. As well, the kiosk 18 is in communication with the central processing unit 14 via a direct connection of network. The P.O.S. terminal 16 and the kiosk 18 are both operable to interface with a consumer and/or clerk and thus include any necessary hardware, software, and logic and/or circuitry.

The central processing unit 14 includes a storage device 20, memory 22, and a processor 24. The storage device 20, in one form, may be a data warehouse. In any form, the storage device 20 is operable to receive and store data from the P.O.S terminal 16 as well as the kiosk 18 such as data obtained and/or generated during a purchase transaction. Data may be stored in a database or databases. Data from other sources may be received and stored in the storage device 20. The storage device 20 may also store programs/instructions (software) for execution by the processor 24 and, particularly, to implement the functionality and/or features of the present invention.

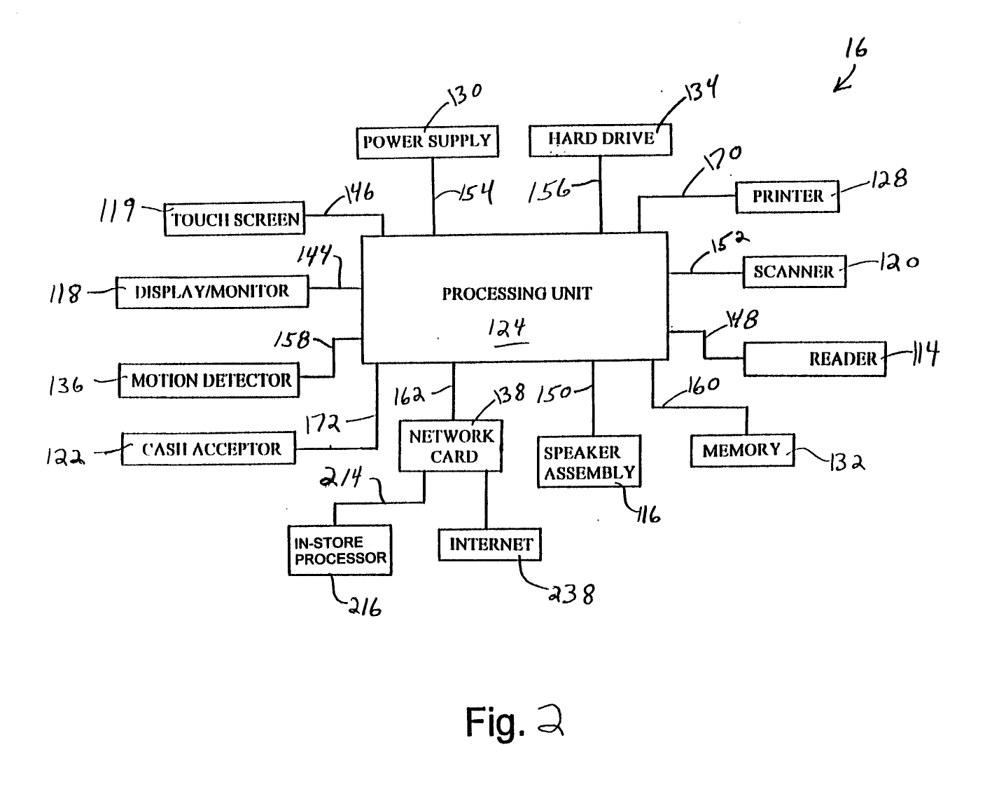

Referring to FIG. 2, there is shown a block diagram of the various components of the P.O.S. or retail terminal 16 and their interconnection(s). The block diagram of FIG. 2 is applicable to other types of retail terminals, kiosks, and the like. The P.O.S terminal 16 has a processing unit or circuitry 124 as is known in the art that includes a processor or microprocessor and associated circuitry as the main controller for or of the P.O.S. terminal 16. The processing unit 124 is in electronic communication with a typical power supply 130 via a power line 154. The power supply 130 is coupled to a source of electricity (not shown) and is transformed appropriately as is known in the art for use by the processing unit 124.

The reader 114 is electronically coupled to the processing unit 124 via a communication line 148 that allows communication between the processing unit 124 and the reader 114. Information from a user's card is thus obtained by the reader 114 and used/processed by the processing unit 124. This may occur during ordering of a product and/or payment thereof, the retrieving of information. One manner of payment may be through a debit card, a charge card, a smart card, or the like (collectively “card”) or via a check. Information from the card or check is obtained via the reader 114. The reader 114 also may obtain information from a magnetic strip of a loyalty card. Personal preference data encoded onto the magnetic strip may also be read by the reader 114

A display 118 is electronically coupled to the processing unit 124 via a communication line 144 that allows communication between the processing unit 124 and the display 118. The display 118 is used to show various icons, graphics, windows, video, screens and/or areas (i.e. PIN entry area, billing application screen, personal preferences menu etc.), and through the touch-screen 119 has capabilities that allow for user/consumer interaction with the retail terminal 16. The touch-screen 119 overlays the display 118 and is in electronic communication with the processing unit 124 via communication line 146 to operate in conjunction with the display 118.

Additionally, the speaker assembly 116 is also electronically coupled to the processing unit 124 via a communication line 150 that allows audio information (stereo or mono) to pass to the speakers. The audio information may be music, discourse (i.e. messages, instructions, answers to queries, or the like), or a combination of music and discourse.

Further, the scanner 120 is electronically coupled to the processing unit 124 via a communication line 152 that allows communication between the processing unit 124 and the scanner 120. The scanner 120 is adapted to obtain a scan of a bar code and/or graphics on an object in proximity thereto such as a product, label or tag having a UPC (universal product code). Barcoded personal privacy preferences are also read by the scanner 120. In order to accomplish a scan, the consumer moves the object (e.g. product) thereunder such that the bar code on the object may be read by the scanner 120. The scanner 120 is typically always in an active mode during normal operation of the retail terminal such that the bar code of an object will be immediately scanned or read when the object is placed thereunder. The scanner 120 may also read other information, coded or not, in various forms.

The retail terminal 16 may additionally include a motion detector 136 that is electronically coupled to the processing unit 124 via a communication line 158. The motion detector 136, in conjunction with the processing unit 124 and associated software, can be used to detect whether a customer is within a detection zone around the retail terminal 16 in order to allow the retail terminal 10 to perform an action or enter into a certain mode of operation.

As an example, the motion detector 136 and scanner 120 may work in tandem such that the scanner 120 is normally off when the motion detector 136 does not detect the presence of a consumer within the detection zone, but which activates the scanner 120 when a consumer is within the detection zone. After a predetermined time of inactivity, the scanner 120 may be deactivated until another triggering event has occurred (e.g. a consumer within the detection zone). As well, various types of motion of a consumer within the detection zone may trigger the scanner into activation.

The retail terminal 16 may include a hard drive 134 or other similar local or internal mass storage device that is in electronic communication with the processing unit 124 via a communication line 156. The hard drive 134 may be used to store programs or the like, and any other information that allows the retail terminal 10 and its various components to function in accordance with the principles espoused herein. The programs may be stand-alone programs for the operation of the retail terminal 16 or may be supplementary (e.g. modules) to main programs stored on the network 206, and may include at least part of a personal privacy preferences program to allow the consumer to use the P.O.S. terminal 16 to set personal privacy preferences. The hard drive 134 may also locally store program instructions as described below that can be correlated to various purchase transaction data which is obtained/acquired during a purchase transaction that has transpired on the retail terminal 16.

As well, the processing unit 124 may be in communication with a memory device (or devices) 132 such as RAM or ROM via communication line 160 that may be used to temporarily or permanently store program/program instructions/modules/components and other information as is necessary for operation of the retail terminal 16 as well as perform personal privacy preference programming. The memory 132 may also store program information (programs/instructions) for the operation of the retail terminal and its components as described herein. Other program instructions required to carry out the various functions as described herein may also be stored therein.

A network card 138, modem or the like (collectively network card) may be installed in the retail terminal 16. The network card is in electronic communication with the processing unit 124 via a communication line 162. The network card 138 allows the connection of the retail terminal 10 to an in-store processor 216 (such as the processor 24 of the central processing unit 14) via network 214. The network card 138 also allows connection to the Internet 238 (or network 26 of FIG. 1).

The retail terminal 16 may be in electronic communication with a printer 128 via a communication line 170 for providing a printout or hard copy of information regarding a transaction or transaction data during or after a purchase transaction. As well, the printer 128 may print on the check a generated tender code or the generated tender code to be applied to the check. The memory 132 typically temporarily stores program instructions that are executable by the processing unit 124 in order for the retail terminal 16 to process the purchase transaction.

The memory 22 may be RAM, ROM, or other type of memory, that is used in conjunction with the processor 24 in a known manner for processing instructions stored thereon or in the storage device 20. The stored instructions when processed and/or implemented by the processor 24 provide the features and/or functionalities described herein. Such instructions may be in any language and form.

The business 12 collects transaction data and personal data from the P.O.S. terminal 16 as well as the kiosk 18, and any network devices (i.e. kiosk 30, and business 28). This data is stored in the storage device 14 and may be processed in various manners. In accordance with an aspect of the present invention, the type of personal data collected by the business 12 is dependent upon a consumer's personal privacy preferences or a privacy profile. The personal privacy preferences are selectable by the consumer and represent a privacy data model. As well, the consumer may opt out of data collection altogether or opt out of a specific part. Thus, when a transaction takes place at the P.O.S. terminal 16 and/or kiosk 18, the privacy data model (personal privacy preferences or privacy profile) for the consumer who is a party to the transaction is obtained. Personal data is then collected based on the obtained privacy data model.

The privacy data model is coded or encoded onto a code storage media (such as the code storage medium 44) that is used or accessed by the business 12 during a transaction. The code storage media may be coded as a barcode or the like, or may be encoded into a barcode for other purposes. As well, the privacy data model may be coded/encoded onto a key flock or card via a magnetic strip. Other means of coding and storage may be used consistent with the principles presented herein. As explained in greater detail below, the consumer is able to prescribe his/her privacy data model via various methods.

The business 12 may be in communication with a public or private network 26 (e.g. the Internet). This allows the business 12 to be in communication with a business 28 that is likewise in communication with the network 26. The business 28 may be a totally other business, a franchise business, another business location of the business 12, or the like. The business 28 preferably includes the components/elements as well as the functionality of the business 12.

The business 12 may also have a kiosk 30 at a remote location such as an automated teller machine (ATM) or the like that is in communication with the business 12 via the network 26. It should be appreciated that the kiosk 30 may represent a plurality of kiosks that are in communication with the business 12. The kiosk 30 includes the same features, components, and/or functionality as the kiosk 18 as described herein.

The business 12 also may be in communication with a storage device 32 via the network 26. The storage device 32 may function in the same manner as the storage device 20 and be used for off-site data storage. Off-site data storage may mirror the data on the storage device 20 in various degrees, or may store different data. The storage device 32 may be a central data warehouse or contain program instructions that are used by the various networked devices. A generic network device 34 is also shown in communication with the business 12 via the network 26. The network device 34 is representative of any type or types of network device(s), particularly those that may aid in the implementation of the present invention.

A consumer has a plurality of consumer devices 36 at their disposal, at least one of which is used to obtain and/or set a consumer's personal privacy preferences and thus compile a privacy data model. Without being exhaustive, consumer devices 36 include a personal computer (PC) 38, a personal digital assistant (PDA) 40, and a cell phone 42. Each one of these consumer devices 36 are connectable so as to be in communication with the network 26, such that the particular consumer device is able to access and download personal privacy preferences from the business 12 or other location. The particular consumer device of the consumer devices 36 thus connects to a personal privacy preferences menu or the like for the business 12 via the network 26 or any other means. Once the consumer device is connected to the personal privacy preferences menu or program, the consumer is able to prescribe, set or determine what type of personal data may be obtained during a transaction, how the personal data is used, and other attributes of personal privacy preferences. The personal privacy preferences are then coded, retained, and forwarded from the business 12 back to the particular consumer device 36.

In one form, the particular consumer device 36 is in communication with a code storage medium 44, such as a barcode generator that outputs a barcode that is encoded with the consumer's particular personal privacy preferences, a key flock, a smart card, or magnetic strip card. The coded information, thus making up a consumer privacy profile or data model is transmitted to the particular consumer device 36 which is translated onto a particular code storage medium 44. The code storage medium 44 is accessed by the business during a transaction to obtain the consumer's personal privacy preferences. The type of encoding or coding of the prescribed personal privacy preferences is dependent upon the type of code storage medium 44, which in turn, may be dependent upon the particular consumer device used.

Alternatively, the particular consumer device 36 is able to access a personal privacy preferences menu of the business 12 and build a personal privacy profile of preferences that is then transferred to a particular code storage medium. A particular consumer device 36 may be used to update the personal profile if desired no matter which of the above methods is used.

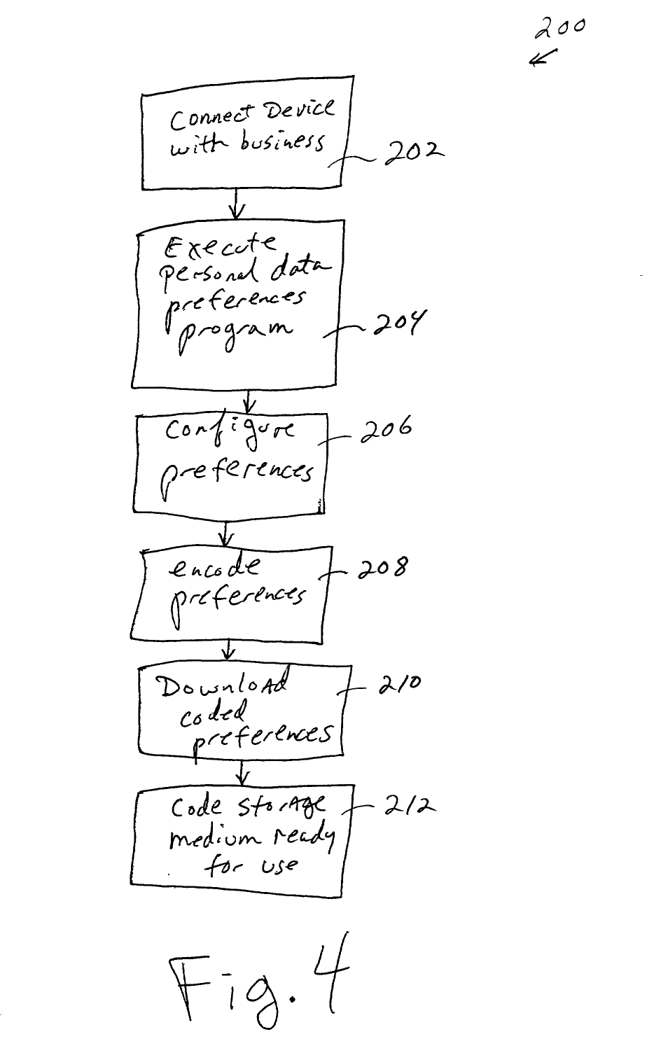

One application of the above is the use of business loyalty cards or frequent shopper card. With reference to FIG. 3, a loyalty card 50 from a consumer has been coded or encoded with preference data 52, preferably via a consumer device 36 as indicated above. The loyalty card 50 is used by the P.O.S. terminal 16 which obtains the preference data 52 from the card during the transaction. The P.O.S terminal then uses the data model to obtain and not obtain personal privacy data during the transaction.

Referring to FIG. 4, there is shown a flowchart, generally designated 200, setting forth a method in accordance with the principles of the present invention. Initially, a consumer connects their device 36 with the business 12 (or place where the personal preferences program is stored and executable) via a network 26 or other means, step 202. Once connected, a personal preference program is executed that allows the consumer's device 36 (i.e. PC 38, PDA 40, cell phone 42, or the like) to interface with the personal preference program in order to select, set, or prescribe personal privacy preferences with respect to various types of personal data, step 204. The consumer then configures his/her own personal/privacy data preferences, step 206. Once various selections have been made, the personal preferences program encodes or codes these preferences, step 208. The encoded/coded personal privacy preferences are then downloaded onto or transmitted to a code storage medium, step 210. The encoded/coded personal privacy preferences define a privacy data model that is thereafter readable by retail terminals, kiosks, and the like. Thereafter, in step 212, the code storage medium is ready to be used.

Different businesses may use different encoding/coding for their personal privacy preferences. In this manner, a smart card may be used as the code storage medium wherein different personal privacy data models may be stored such that a single card may be used in a variety of locations and/or manners.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for consumer prescribing of personal data preferences comprising the steps of:
allowing access to a personal data preferences program via a consumer device;
allowing a consumer to select personal data preferences via the consumer device;
coding the selected personal data preferences;
downloading the coded personal data preferences to the consumer device; and
allowing the consumer device to transfer the coded personal data preferences to a storage media.

2. The method of claim 1, wherein the step of allowing access to a personal data preferences program includes allowing access via an electronic network.

3. The method of claim 2, wherein the electronic network is the Internet.

4. The method of claim 1, wherein the step of coding the selected personal data preferences includes coding the selected personal data preferences into a barcode.

5. The method of claim 1, wherein the step of coding the selected personal data preferences includes coding the selected personal data preferences into a magnetic strip readable format.

6. The method of claim 1, wherein the step of allowing the consumer device to transfer the coded personal data preferences to a storage media includes transferring the coded personal data preferences to a storage media comprising a magnetic strip card.

7. The method of claim 1, wherein the step of allowing the consumer device to transfer the coded personal data preferences to a storage media includes transferring the coded personal data preferences to a storage media comprising a key flock.

8. The method of claim 1, wherein the consumer device is one of a personal computer, a personal digital assistance, and a cell phone.

9. A method of encoding personal data preferences of a consumer for use during a purchase transaction comprising the steps of:
accessing a personal data preferences program via a consumer device;
permitting selection of personal data preferences via the consumer device;
encoding the selected personal data preferences; and
downloading the encoded selected personal data preferences to the consumer device.

10. The method of claim 9, wherein the consumer device comprises one of a personal computer, a personal digital assistant, and a cell phone.

11. The method of claim 9, further comprising the step of:
transferring the downloaded encoded selected personal data preferences onto a code storage device, the code storage device being readable by a retail terminal during a purchase transaction.

12. The method of claim 11, wherein the code storage device comprises one of a key flock, access card, and a barcode.

13. The method of claim 9, wherein the step of encoding the selected personal data preferences includes:
encoding the selected personal data preferences into a barcode format.

14. The method of claim 9, wherein the step of encoding the selected personal data preferences includes:
encoding the selected personal data preferences into a magnetic strip readable format.

15. The method of claim 9, wherein the step of accessing a personal data preferences program by a consumer device includes utilizing a network.

16. The method of claim 15, wherein the network comprises the Internet.

17. A system for prescribing personal data preferences comprising:
a processing unit;
a network interface in communication with the processing unit and operable to be coupled to an electronic network; and
memory in communication with said processing unit and containing a plurality of instructions which, when executed by the processing unit, causes (a) a consumer device to access a personal data preferences program via the electronic network; (b) allow a consumer via the consumer device to select personal data preferences; (c) convert the selected personal data preferences into a personal data model; (d) code the personal data model in a format readable by a retail terminal during a purchase transaction; and (e) transmitting the coded personal data model to the consumer device, wherein the consumer device is operable to transfer the received coded personal data model onto a personal data preferences storage medium.

18. The system of claim 17, wherein said consumer device is one of a personal computer, a cell phone, and personal digital assistant.

19. The system of claim 17, wherein the coded personal data model is encoded into a barcode format.

20. The system of claim 17, wherein the coded personal data model is encoded into a magnetic strip format.
